(19) United States
(12) Patent Application Publication
(10) Pub. No.: US 2013/0278608 A1
(43) Pub. Date: Oct. 24, 2013

(54) Plant Simulation for Graphics Engines

(71) Applicants: Dmitry Ragozin, Nizhny Novgorod (RU); Sergey Belyaev, Saint Petersburg (RU)

(72) Inventors: Dmitry Ragozin, Nizhny Novgorod (RU); Sergey Belyaev, Saint Petersburg (RU)

(21) Appl. No.: 13/994,148

(22) PCT Filed: Nov. 4, 2011
(86) PCT No.: PCT/US11/59256

§ 371 Date: Jun. 14, 2013

(51) Int. Cl. G06T 13/60

(52) U.S. Cl. CPC G06T 13/60
USPC 345/473

(57) ABSTRACT

Plants may be visualized using an inertial animation model with Featherstone algorithm. Different levels of detail may be used for different blocks of plants.

### BACKGROUND

This relates generally to computers and, particularly, to graphics processors.

The motion of vegetation, usually in the background of a scene, is extremely complex. For example, grass in a field may consist of thousands, if not millions, of individual grass blades. Each of those blades may move in a unique way based on its shape and its position within the landscape, as affected by the wind and its interaction with the ground's shape.

### BRIEF DESCRIPTION OF THE DRAWINGS

FIG. 1 is a schematic depiction of one embodiment of the present invention;

FIG. 2 depicts grass blocks on a terrain in accordance with one embodiment;

FIG. 3 shows how density thresholds for a grass block may vary across the block in accordance with one embodiment;

FIG. 4 depicts the building of an i-level block from an (i−1) level block in accordance with one embodiment;

FIG. 5 depicts blocks fragments;

FIG. 6 illustrates the generation of weight coefficients in accordance with one embodiment;

FIG. 7 is an illustration of the allocation of blocks with different levels of detail;

FIG. 8 is a blade model for n=4 in accordance with one embodiment;

FIG. 9 illustrates forces and torques applied to a blade segment;

FIG. 10 depicts blade torsion around a central axis because of wind;

FIG. 11 shows grass blade interaction between adjacent grass blades;

FIG. 12 is a blade static equilibrium diagram;

FIG. 13 is a scheme of virtual-inertia modeling in accordance with one embodiment;

FIG. 14 is a blade static equilibrium under impact of a virtual wind force w in accordance with one embodiment; and

FIG. 15 is a schematic depiction of one embodiment of the present invention.

### DETAILED DESCRIPTION

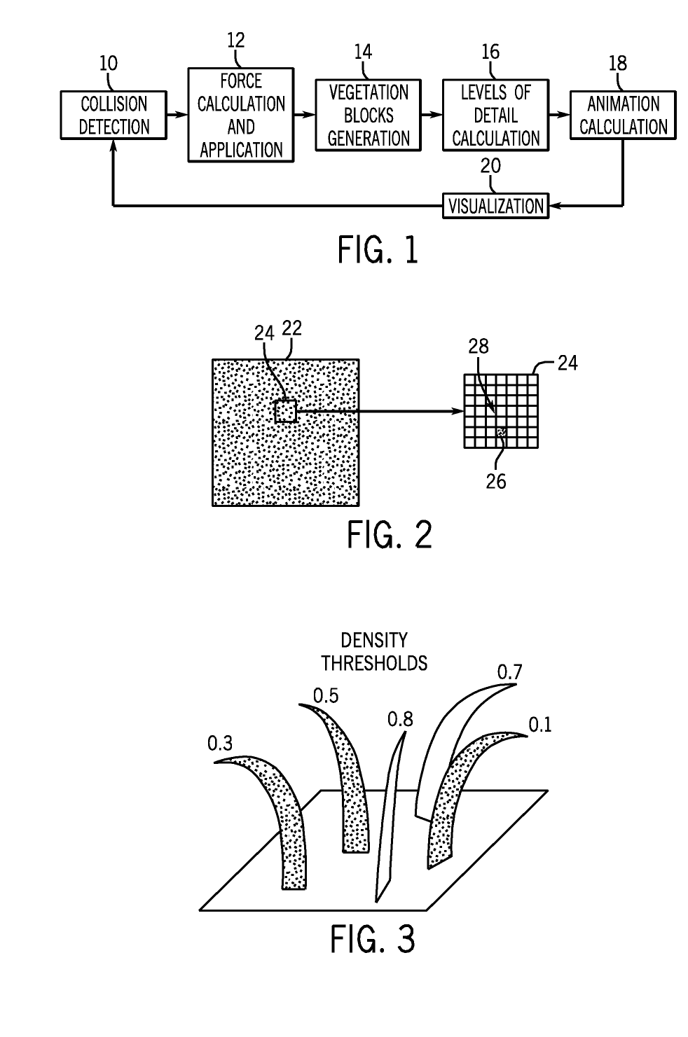

Referring to FIG. 1, virtual vegetation for graphics processing may interact with moving and static objects and physical phenomena, such as the wind, with multiple levels of detail in some embodiments. Collision detection, block 10, checks for collisions between real world objects, such as car wheels or soldier's feet, and the simulated plants. State of the art collision detection methods may employ well-known complex algorithms and data structures to speed up finding intersections between objects in the virtual world.

Force calculation and application block 12 calculates the collision force for a set of plant units, such as grass blades. Vegetation blocks generation 14 may rebuild graphics objects for blocks in the camera frustrum if the camera position has changed. A vegetation block is a rectangular/region or a tile in a rectangular grid of blocks that together define the overall vegetation depiction. This stage defines which vegetation blocks are displayed with the highest detail level, with moderate detail level, or with the lowest detail level, in an embodiment using three levels of detail.

The levels of detail are calculated (block 16) based on the results from the preceding block. The final list of visualized objects is formed for herbage blocks in the camera frustrum. The animation calculation 18 generates blades, bit maps, and/or textures and visualization unit 20 produces a display, using the graphics processing unit hardware.

Blocks 10-14 may be executed on a central processing unit (CPU) and blocks 16-20 may be executed on the graphics processing unit (GPU), in some embodiments. However, any block can be moved from CPU to GPU or vice versa, depending on the computing system architecture.

In accordance with some embodiments, physics model improvements may improve user experience. Optimized visualization techniques with several levels of detail enable graphics processing, especially for energy constrained graphics processing units, such as those used in mobile applications. The herbage model may introduce inertial animation models with the Featherstone algorithm. This includes true physics blade behavior during interaction with physical phenomena, such as the wind, or external objects, such as wheels and feet. Optimized visualization techniques include automatically changing levels of detail with smooth transitions, automatic filling of terrain blocks with blades, allowing the decrease of the overall number of visualized blades by a factor of 10×, or even more, in some embodiments.

For grass visualization, a geometry-based approach may be used. Accordingly, rectangular terrain blocks 24 are created, each consisting of a set of separate blades of the same kind (FIG. 2). These blocks are visualized on the terrain surface 22. A set of grass blocks of the same type makes up the rectangular grid 28 (FIG. 2) which is mapped onto terrain in such a way that the central cell of the grid appears just under the camera. When the camera moves on the adjacent grid cell, the whole grid is moved on the grid cell size.

To enable smooth changing of level of detail, a weight coefficient is assigned to each blade in the block (see FIG. 3). When visualizing, the blade is discarded, if the following condition is valid:

w<F(z,φ) (1)

where w is the weight coefficient, F is some function, z is the distance from the camera to the blade, φ is the angle between direction to the camera and normal to the terrain surface in the blade point.

Further, F function is as follows:

$$F ( z , ϕ ) = 1 - clamp ( \frac{( 1 - t ) ( n , r ) + t}{{a}_{1} + {a}_{2} d + {a}_{3} {d}^{2}} , 0.1 )$$

where n is the normal to the terrain surface and r is the direction to the camera, d is the camera distance, t=(1−|(n,r)|)^{α}, and α is a big number (e.g. 8).

This function may be used both for discarding grass blades when inequality, equation (1), is valid and for selecting the block's discrete level of detail. In the first case, d is the distance from the camera to the grass blade, in the second, d is the distance to the block center.

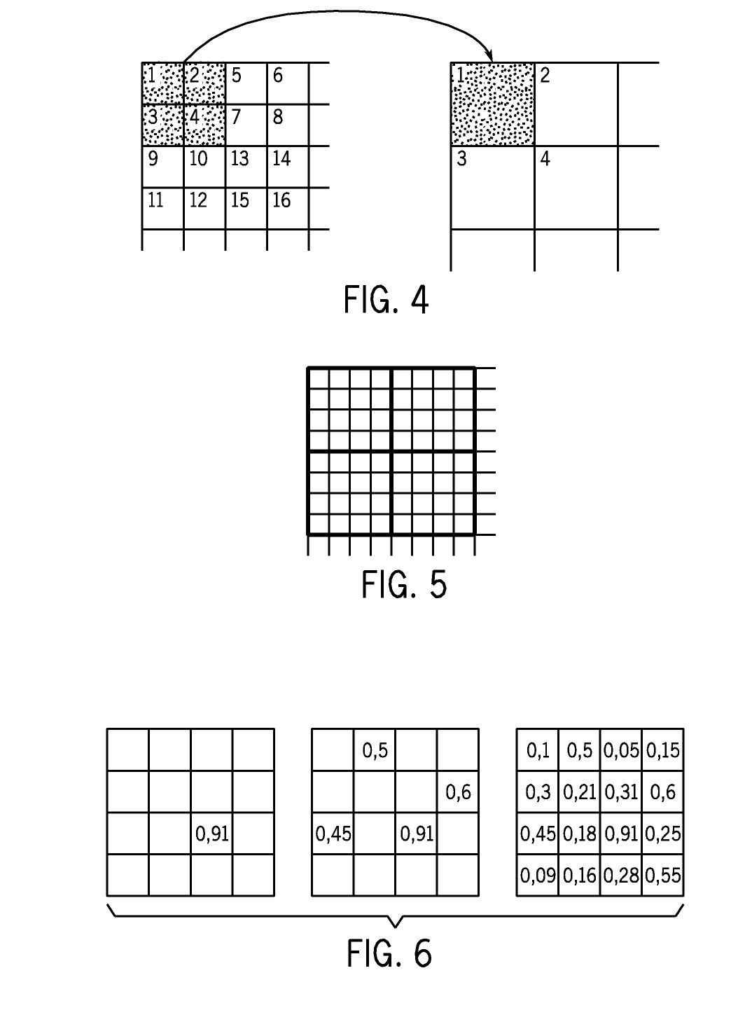

Discrete levels are introduced in the following way. Let the number of blades in the block be N=2^{k}. Also the blades may be stored in the memory according to enumeration shown in FIG. 4. To generate the block of less detail, four sequential blades from the current block, with the maximum weight, are selected and put into a new block. The result is shown in FIG. 4. The block of the next detail level is produced with the same algorithm.

An algorithm to generate weight coefficients may be as follows. Split a block into (n/4)*(n/4) fragments (FIG. 5). For each fragment, generate a random number in ⅔, 1 and assign it to the random blade in the fragment. Then we get 3 random numbers in [⅓, ⅔) interval and assign these numbers to random blades located in the squares, excluding the square already having the blade with the weight. At last, assign random numbers from [0, ⅓) interval to the remaining blades (FIG. 6).

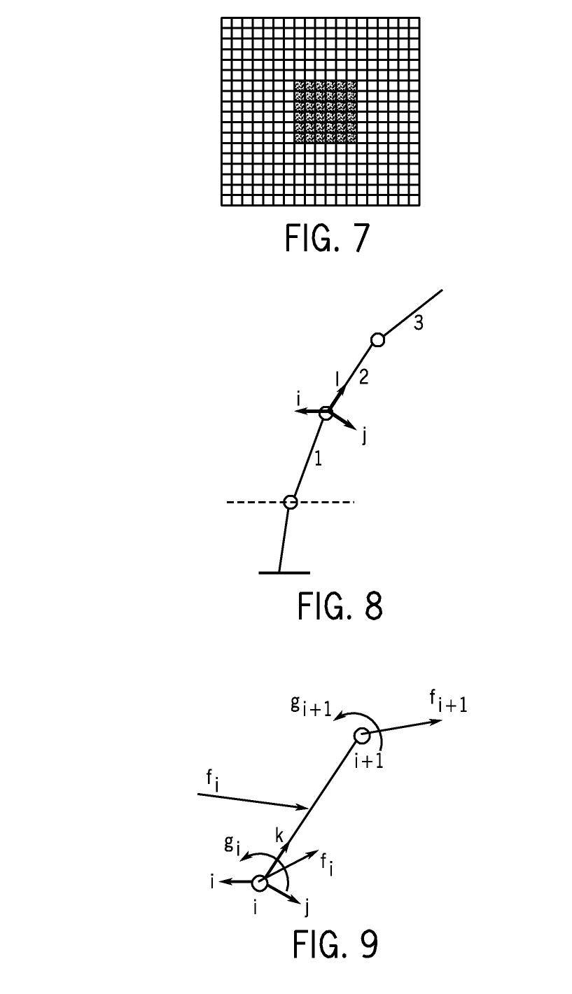

Approximate distribution of the blocks with various levels of detail within the central square is shown in FIG. 7. It is evident that the number of low detail blocks is much more than the number of high detail ones. Therefore, the number of the visualized blades may be much less.

To reduce the average number of triangles for one blade, various ways for triangulation on various levels of block detail may be used. Near the camera a blade may be visualized with seven segments (14 triangles). The number of segments is reduced the further the vegetation is from the camera.

The blade model is represented as a chain of n linear segments, connected to each other with joints which have spherical springs (FIG. 8). The rigidity of these springs is denoted as kᵢ, where i is the number of the joint.

The coordinate system is assigned to each segment (FIG. 8). The segments and joints are enumerated bottom-up. A zero segment is a dummy and determines initial rotation and tilt angles the blade when planting. Ground level is at the height of the lower end of the first segment (joint 1).

The rotations of the segments are defined by two vectors: v vector defines rotation around y axis at ∥v∥ angle. The corresponding rotation matrix is the following:

$$M ( v , θ ) = ( \begin{matrix}cos θ + ( 1 - cos θ ) {x}^{2} & ( 1 - cos θ ) xy - ( sin θ ) z & ( 1 - cos θ ) xz + ( sin θ ) y \\ ( 1 - cos θ ) yx + ( sin θ ) z & cos θ + ( 1 - cos θ ) {y}^{2} & ( 1 - cos θ ) yz - ( sin θ ) x \\ ( 1 - cos θ ) zx - ( sin θ ) y & ( 1 - cos θ ) zy + ( sin θ ) x & cos θ + ( 1 - cos θ ) {z}^{2}\end{matrix} )$$

where θ is the rotation angle equal to ∥v∥ and x, y, z are coordinates of singular vector v/∥v∥ of the rotation axis. The matrix is denoted further as M(v). The inverse transform to get rotation vector from rotation matrix is:

v=V(M)=((m₃₂−m₂₃)/q,(m₁₃−m₃₁)/q,(m₂₁−m₁₂)/q)

q=\sqrt{4−(m₁₁+m₂₂+m₃₃−1)²}

The external forces f^{e}ᵢ, which are the sum of the wing force and segment gravity (FIG. 9) are applied to the segment centers.
The movement equation for i^{th} segment in its coordinate system is the following:

J\dot{ω}ᵢ=−ωᵢ×(Jωᵢ)−m1×R′ᵢaᵢ₋₁−gᵢ+Rᵢ₊₁gᵢ₊₁+1×(2Rᵢ₊₁fᵢ₊₁+T′ᵢfᵢ^{e}) (1)

a*ᵢ=\dot{ω}ᵢ×1ωᵢ×(ωᵢ×1) (2)

aᵢ=aᵢ₋₁+a*ᵢ (3)

\dot{ψ}ᵢ=ωᵢ (4)

f*ᵢ=−m(R′ᵢaᵢ₋₁+a*ᵢ) (5)

fᵢ=f*ᵢ+T′ᵢfᵢ^{e}+Rᵢ₊₁fᵢ₊₁ (6)

Where J is the inertia tensor (non-diagonal elements are zero),
ωᵢ is the angle velocity vector of i^{th} segment,
ψᵢ is a vector which determines rotation increment of the coordinate system of i^{th} segment, relatively to the coordinate system of (i−1)^{th} segment,
gᵢ is the moment caused by spring in i^{th} joint,
Rᵢ is a matrix converting vectors from the coordinate system of i^{th} segment to the coordinate system of (i−1)^{th} segment (when i=0—to the world coordinate system),
Rᵢ′ is an inverse matrix to Rᵢ, converting vectors from the coordinate system of (i−1)^{th} segment to the coordinate system of i^{th} segment,
Tᵢ′ is a matrix, converting vectors from the world coordinate system to the coordinate system of i^{th} segment. Note that

$${T}_{i} = {\prod }_{j = 0}^{i} {R}_{j} ,$$

aᵢ is an acceleration at the end of i^{th} segment, i.e. in (i+1)^{th} joint, but calculated in the coordinates of i^{th} segment,
l=(0,0,l)′, where l—a half of the segment length (all segments have the same length with the center of mass in the middle),
m is a mass of the segment (all segments have the same mass).
For integration of the system (1)-(6) Featherstone algorithm is used. Two passes at each time step are done. At the first pass new values Rᵢ, Tᵢ, ωᵢ, gᵢ are calculated using known values Rᵢ, Tᵢ, ωᵢ, gᵢ, fᵢ from the previous step.
This is done by bottom-up calculations along i, which allows to calculate acceleration aᵢ using equality a₀ to zero.
It is assumed that: 1) angle velocities are small; 2) impact of higher segments on lower is much less than reversed impact. So the model is simplified (the first assumption allows to discard members which contain squares of angular velocities in equations (1)-(6), and the second allows to refuse the second pass in Featherstone algorithm. The following algorithm is the result of the simplification:

| | |
|---|---|
| T₀=R₀ | |
| for (i=1; i<n; i++) | |
| { | |
| J\dot{ω}ᵢ = −gᵢ +l×Tᵢ′fᵢ^{e} | |
| \dot{ψ}ᵢ = ωᵢ | (7) |
| Rᵢ = Rᵢ M(^{ψ}^{ᵢ}) | |
| Tᵢ=Tᵢ₋₁Rᵢ | |
| gᵢ=kᵢV(Rᵢ) | |
| } | |

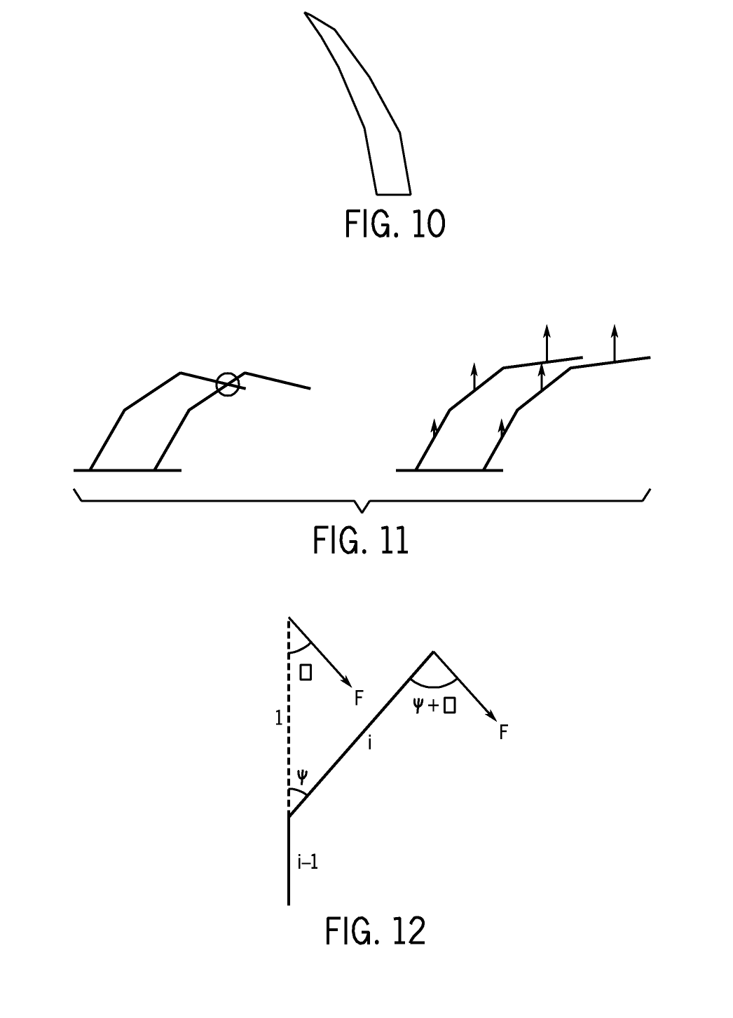

The described model provides not only the blade bend caused by the forces, but also its torsion around central axis if the wind force is not perpendicular to the blade plane, as shown in FIG. 10.

The algorithm keeps good visual illusion of animated grass blades in some embodiments.

Because of the huge number of grass blades it is hard to simulate their mutual collisions. However, the fact is considered that in case of blade inclination the collision of its top with the middle segment of another blade, as shown in FIG. 11, left side, becomes more probable.

For this purpose additional forces are applied to each blade segment (FIG. 11, right side) with values which are proportional to the slope angles of the segments. These forces are directed against weight forces, so the weight force of the segment is reduced proportionally to its slope angle:

fᵢ^{e}=fᵢ^{w}+GᵢTᵢ′[2,2]

where fᵢ^{w} [symbol] Gᵢ are wind and weight forces relatively.
The velocity of the segment is considered while calculating the wind force for each blade segment:

fᵢ^{w}=k_{w}(w−vᵢ)^{γ}

Here k_{w} is a coefficient which depends on the blade width, w is a wind velocity, vᵢ is a segment center velocity, γ is a constant which depends on the grass type (for example, γ=4/3 for sedge). The vᵢ value is calculated using vᵢ₋₁* (velocity of the top of previous segment) according to formula vᵢ=vᵢ₋₁*+Tᵢ(l×ωᵢ)
Velocities of the segment tops are found from recurrent relations

v₀*=0

vᵢ*=vᵢ₋₁*+2Tᵢ(l×ωᵢ)

Therefore, algorithm (7) takes the form

T₀=R₀
v₀* = 0
for (i=1; i<n; i++)
{
r = Tᵢ(l×ωᵢ)
vᵢ = vᵢ₋₁* + r
vᵢ* = vᵢ₋₁* + 2r
fᵢ^{w} = k_{w} (w − vᵢ)
fᵢ^{e} = fᵢ^{w} + GᵢTᵢ′[2,2]
J\dot{ω}ᵢ = − gᵢ + l × T′ᵢfᵢ^{e}

\dot{ψ}ᵢ = ωᵢ

Rᵢ =RᵢM(ψᵢ)
Tᵢ=Tᵢ₋₁Rᵢ
gᵢ=kᵢV(Rᵢ)
}

In a non-inertial animation model, the static equilibrium of a blade under gravity and wind forces is considered. So the animation is reached because of changing wind force. As well as in the simplified model (7) higher segments' impact onto lower ones may be disregarded.

gᵢ=l×Tᵢ′fᵢ^{e}

Taking into account that

Tᵢ=Tᵢ₋₁M(kᵢ⁻¹gᵢ)

the equality for calculating gᵢ moment is:

gᵢ=l×(Tᵢ₋₁M(kᵢ⁻¹gᵢ))′fᵢ^{e}

Since gᵢ moment is linearly bound with rotation vector (Hook's law), instead of this equation the following one is considered:

kᵢψᵢ=l×M′(ψᵢ)F

where

F=Tᵢ₋₁′fᵢ^{e}

Evidently, ψᵢ vector's direction coincides with l×F direction. This vector value (FIG. 12) is defined with the equation:

lψ=|F∥l|sin(ψ+φ)

Where

φ=arcsin(|F×l|/|F∥l|)

For solving this equation, a simple iteration method may be used, where an initial approximation which is valid for small ψ values is selected:

ψ=k⁻¹|F∥l|sin(φ)/(1−k⁻¹|F∥l|cos(φ)

Three iterations are enough for coinciding visual results for the approximation, in some embodiments.
Therefore the algorithm is considered that finds Tᵢ′ matrices that define segment mapping to the world coordinate system:

T = T₀
for (i=1; i<n; i++)
{
F = T′fᵢ^{e}
ψ = l×F/|F||l|)
φ = arcsin(|ψ|)
ψ = k⁻¹|F||l|sin(ψ + φ)
Tᵢ = TM(ψψ)
T = Tᵢ
}

This model is compliant with the visualization method based on allocation of the same block over the entire grass surface, as there is no need to know its previous state for calculating the blade shape under wind.

The virtually-inertial animation model provides results close to inertial model, but it does not require keeping current values of angle velocities and general displacements for each grass blade so enables instancing use during rendering.

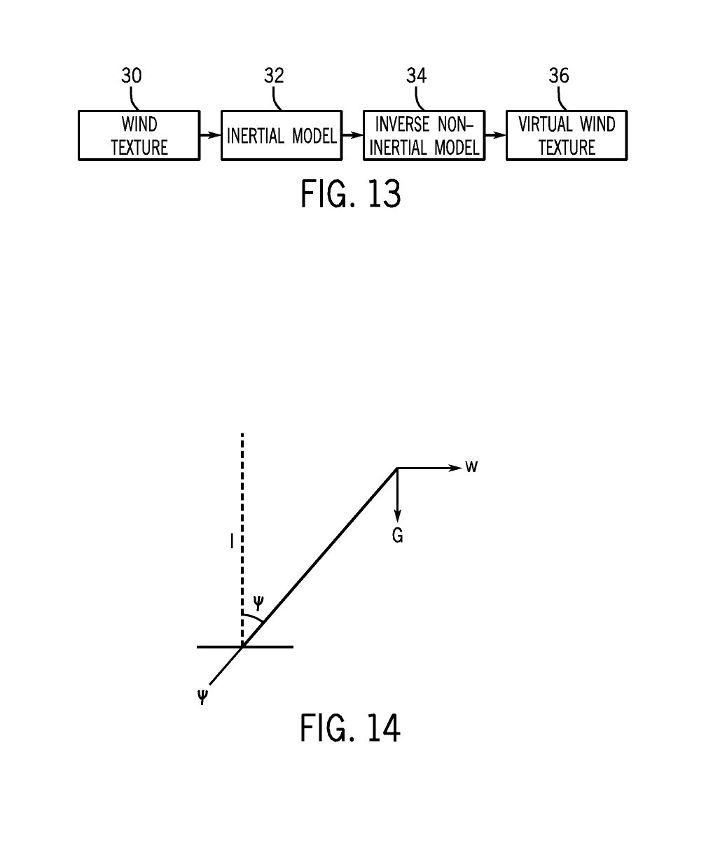

The idea of the virtually-inertial model is to carry over inertial component from calculation of the blade shape towards calculation of the wind force for this blade. That may be done if vertical virtual blades (which consist of one segment) are put into centers of wind force texels and their slope is calculated with inertial model. After that the wind force is calculated and it is applied to non-inertial model in order to get the same slope value as a result. This wind force is kept in the virtual wind texture (block 36, FIG. 13) that is used for the grass blade animation when rendering with instancing, instead of the actual wind force calculation.

As shown in FIG. 13, the wind texture (block 30) is used in the inertial model 32. Inverse non-inertial model 34 calculates the virtual wind force w so that static equilibrium condition is valid (see FIG. 14) with the bend of virtual blade of 2l length by the angle calculated in inertial model ψ and weight force G.

The vector's w direction coincides with the vector product of ψ vector and vertical axis, and its value is equal to:

$$w = \frac{k ψ - l sin ψ}{l cos ψ}$$

where k is the rigidity of the first blade segment used in inertial model.

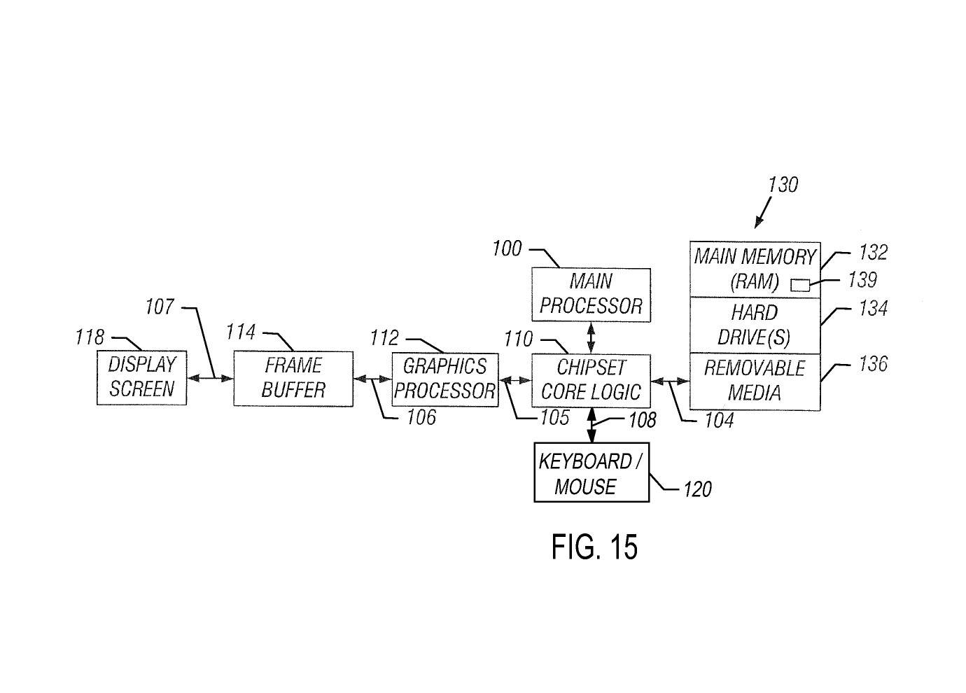

The computer system 130, shown in FIG. 15, may include a hard drive 134 and a removable medium 136, coupled by a bus 104 to a chipset core logic 110. The computer system may be any computer system, including a smart mobile device, such as a smart phone, tablet, or a mobile Internet device. A keyboard and mouse 120, or other conventional components, may be coupled to the chipset core logic via bus 108. The core logic may couple to the graphics processor 112, via a bus 105, and the central processor 100 in one embodiment. The graphics processor 112 may also be coupled by a bus 106 to a frame buffer 114. The frame buffer 114 may be coupled by a bus 107 to a display screen 118. In one embodiment, a graphics processor 112 may be a multi-threaded, multi-core parallel processor using single instruction multiple data (SIMD) architecture.

In the case of a software implementation, the pertinent code may be stored in any suitable semiconductor, magnetic, or optical memory, including the main memory 132 (as indicated at 139) or any available memory within the graphics processor. Thus, in one embodiment, the code to perform the sequences of FIGS. 1 and 13 may be stored in a non-transitory machine or computer readable medium, such as the memory 132, and/or the graphics processor 112, and/or the central processor 100 and may be executed by the processor 100 and/or the graphics processor 112 in one embodiment.

FIGS. 1 and 13 are flow charts. In some embodiments, the sequences depicted in these flow charts may be implemented in hardware, software, or firmware. In a software embodiment, a non-transitory computer readable medium, such as a semiconductor memory, a magnetic memory, or an optical memory may be used to store instructions and may be executed by a processor to implement the sequences shown in FIGS. 1 and 13.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
using, in a computer processor, an inertial animation model with Featherstone algorithm to render interaction of plants with physical phenomena.

2. The method of claim 1 including providing visualization with a plurality of levels of detail.

3. The method of claim 2 including automatically filling terrain blocks with plant depictions.

4. The method of claim 2 including assigning different levels of detail to different blocks.

5. The method of claim 2 including performing collision detection between plants in a central processing unit.

6. The method of claim 5 including determining levels of detail in a graphics processing unit.

7. The method of claim 2 including assigning a weight coefficient to each plant in a block.

8. The method of claim 1 including visualizing plants using triangles, the farther the plant is from the camera, the less triangles are used for visualization.

9. The method of claim 1 including representing grass blades as spherical springs.

10. The method of claim 1 including using a virtually inertial animation model.

11. A non-transitory computer readable medium storing instructions executed by a computer to:
build an inertial animation model with Featherstone algorithm to render interaction of plants with physical phenomena.

12. The medium of claim 11 further storing instructions to provide visualization with a plurality of levels of detail.

13. The medium of claim 12 further storing instructions to fill terrain blocks with plant depictions.

14. The medium of claim 12 further storing instructions to assign different levels of detail to different blocks.

15. The medium of claim 12 further storing instructions to perform collision detection between plants in a central processing unit.

16. The medium of claim 15 further storing instructions to determine levels of detail in a graphics processing unit.

17. The medium of claim 12 further storing instructions to assign a weight coefficient to each plant in a block.

18. The medium of claim 11 further storing instructions to visualize plants using triangles, the farther the plant is from the camera, the less triangles are used for visualization.

19. The medium of claim 11 further storing instructions to represent grass blades as spherical springs.

20. The medium of claim 11 further storing instructions to use a virtually inertial animation model.

21. An apparatus comprising:
a computer processor to create an inertial animation model with Featherstone algorithm to render interaction of plants with physical phenomena; and
a memory coupled to said processor.

22. The apparatus of claim 21, said processor to provide visualization with a plurality of levels of detail.

23. The apparatus of claim 22, said processor to fill terrain blocks with plant depictions.

24. The apparatus of claim 22, said processor to assign different levels of detail to different blocks.

25. The apparatus of claim 22, said apparatus including a central processing unit and a graphics processing unit coupled to said central processing unit, said central processing unit to perform collision detection between plants.

26. The apparatus of claim 25, said graphics processing unit to determine levels of detail.

27. The apparatus of claim 22, said processor to assign a weight coefficient to each plant in a block.

28. The apparatus of claim 21, said processor to visualize plants using triangles, the farther the plant is from the camera, the less triangles are used for visualization.

29. The apparatus of claim 21, said processor to represent grass blades as spherical springs.

30. The apparatus of claim 21, said processor to use a virtually inertial animation model.
